(19) United States
(12) Patent Application Publication
(10) Pub. No.: US 2024/0062782 A1
(43) Pub. Date: Feb. 22, 2024

(54) NONLINEAR LIGHT ABSORPTION MATERIAL, RECORDING MEDIUM, METHOD FOR RECORDING INFORMATION, AND METHOD FOR READING INFORMATION

(71) Applicant: Panasonic Intellectual Property Management Co., Ltd., Osaka (JP)

(72) Inventors: MASAKO YOKOYAMA, Osaka (JP); NAOYA SAKATA, Hyogo (JP); KOTA ANDO, Osaka (JP); TERUHIKO SAITO, Osaka (JP); HIDEKAZU ARASE, Hyogo (JP)

(21) Appl. No.: 18/493,215

(22) Filed: Oct. 24, 2023

Related U.S. Application Data
(63) Continuation of application No. PCT/JP2022/012114, filed on Mar. 17, 2022.

(30) Foreign Application Priority Data
May 18, 2021 (JP) 2021-084182

(51) Int. Cl. G11B 7/244; C09K 11/06; G11B 7/24035

(52) U.S. Cl. CPC G11B 7/244; C09K 11/06; G11B 7/24035

(57) ABSTRACT

A nonlinear light absorption material includes a compound represented by the following formula (1) as a main component:

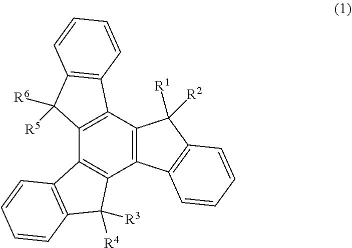

in the formula (1), R¹ to R⁶ are each independently a hydrocarbon group.

### BACKGROUND

### 1. Technical Field

The present disclosure relates to a nonlinear light absorption material, a recording medium, a method for recording information, and a method for reading information.

### 2. Description of the Related Art

Among optical materials such as light absorption materials, a material having a nonlinear optical effect is called a nonlinear optical material. The nonlinear optical effect means that when a material is irradiated with strong light such as laser light, an optical phenomenon proportional to the square or higher power of the electric field of the irradiation light occurs in the material. Examples of the optical phenomenon include absorption, reflection, scattering, and emission. Examples of the quadratic nonlinear optical effect proportional to the square of the electric field of the irradiation light include second harmonic generation (SHG), a Pockels effect, and a parametric effect. Examples of the tertiary nonlinear optical effect proportional to the cube of the electric field of the irradiation light include two-photon absorption, multi-photon absorption, third harmonic generation (THG), and a Kerr effect. In the present specification, multi-photon absorption such as two-photon absorption may be called nonlinear light absorption. A material that can perform nonlinear light absorption may be called a nonlinear light absorption material. In particular, a material that can perform two-photon absorption may be called a two-photon absorption material.

Many studies have been actively conducted on nonlinear optical materials. In particular, as nonlinear optical materials, inorganic materials from which single crystals can be easily prepared have been developed. In recent years, nonlinear optical materials made of organic materials are expected to be developed. Organic materials, compared to inorganic materials, have not only a high degree of design freedom but also a large nonlinear optical constant. Furthermore, in organic materials, a nonlinear response is performed at a high speed. In the present specification, a nonlinear optical material including an organic material may be called an organic nonlinear optical material.

### SUMMARY

In one general aspect, the techniques disclosed here feature a nonlinear light absorption material comprising a compound represented by the following formula (1) as a main component:

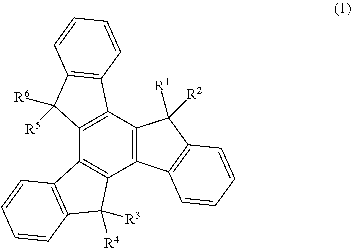

in the formula (1), R¹ to R⁶ are each independently a hydrocarbon group.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a flow chart of a method for recording information using a recording medium including a nonlinear light absorption material according to an embodiment of the present disclosure; and

FIG. 1B is a flow chart of a method for reading information using a recording medium including a nonlinear light absorption material according to an embodiment of the present disclosure.

### DETAILED DESCRIPTIONS

### Underlying Knowledge Forming Basis of the Present Disclosure

As organic nonlinear optical materials, two-photon absorption materials have received particular attention. The two-photon absorption means a phenomenon that a compound almost simultaneously absorbs two photons and transits to an excited state. As the two-photon absorption, simultaneous two-photon absorption and stepwise two-photon absorption are known. The simultaneous two-photon absorption may be also called non-resonance two-photon absorption. The simultaneous two-photon absorption means two-photon absorption in a wavelength region where there is not one-photon absorption band. The stepwise two-photon absorption may also be called resonance two-photon absorption. In the stepwise two-photon absorption, a compound absorbs a first photon and then further absorbs a second photon to transit to a higher excited state. In the stepwise two-photon absorption, the compound absorbs two photons sequentially.

In the simultaneous two-photon absorption, the amount of light absorbed by a compound is generally proportional to the square of the intensity of the irradiation light and exhibits nonlinearity. The amount of light absorbed by a compound can be used as an index of the efficiency of two-photon absorption. When the amount of light absorbed by a compound exhibits nonlinearity, for example, it is possible to cause absorption of light by the compound at only near the focal point of laser light having a high electric field strength. That is, in a sample including a two-photon absorption material, the compound can be excited at a desired position only. Thus, compounds causing simultaneous two-photon absorption induce a significantly high spatial resolution and are therefore being studied for applications such as a recording layer of a three-dimensional optical memory or a photocurable resin composition for three-dimensional (3d) laser microfabrication. When a two-photon absorption material further has a fluorescence property, the two-photon absorption material can also be applied to a fluorescent dye material that is used in a two-photon fluorescence microscope or the like. If this two-photon absorption material is used in a three-dimensional optical memory, there is also a possibility of adopting a system of reading the ON/OFF state of a recording layer based on the change in fluorescence from the two-photon absorption material. In current optical memories, adopted is a system of reading the ON/OFF state of a recording layer based on the change in the reflectance of light and the change in the absorptance of light in the two-photon absorption material. However, when this system is applied to a three-dimensional optical memory, crosstalk may occur based on a recording layer that is different from the recording layer from which the ON/OFF state should be read.

In two-photon absorption materials, a two-photon absorption cross-section (GM value) is used as an index indicating the efficiency of two-photon absorption. The unit of the two-photon absorption cross-section is GM (10⁻⁵⁰cm⁴·s·molecule⁻¹·photon⁻¹). A large number of organic two-photon absorption materials having a large two-photon absorption cross-section have been proposed. For example, many compounds having a large two-photon absorption cross-section exceeding 500 GM have been reported (for example, Harry L. Anderson et al, “Two-Photon Absorption and the Design of Two-Photon Dyes”, Angew. Chem. Int., Ed. 2009, Vol. 48, pp. 3244-3266). However, in most of the reports, the two-photon absorption cross-sections have been measured using laser light having a wavelength of longer than 600 nm. In particular, near infrared rays having a wavelength longer than 750 nm may also be used as the laser light.

However, in order to apply the two-photon absorption material to an industrial use, a material expressing a two-photon absorption property when irradiated with laser light having a shorter wavelength is required. For example, in the field of three-dimensional optical memory, laser light having a short wavelength can realize a finer condensed light spot and therefore can improve the recording density of a three-dimensional optical memory. In also the field of three-dimensional (3d) laser microfabrication, laser light having a short wavelength can realize shaping with a higher resolution. Furthermore, in the specification of Blu-ray (registered trademark) disk, laser light having a central wavelength of 405 nm is used. As described above, development of a compound having an excellent two-photon absorption property for light in the same wavelength region as that of laser light having a short wavelength can greatly contribute to the development of the industry.

Furthermore, light-emitting apparatuses that emit an ultra-short pulse laser having a high light intensity are of large size and tend to be unstable in operation. Accordingly, such light-emitting apparatuses are difficult to be adopted in industrial use from the viewpoint of versatility and reliability. Considering this fact, in order to apply a two-photon absorption material to industrial use, a material expressing a two-photon absorption property even when irradiated with laser light having a low light intensity is required.

In a compound having a two-photon absorption property, a relationship between the light intensity and the two-photon absorption property is represented by the following expression (i). In the present specification, a compound having a two-photon absorption property may be called a two-photon absorption compound. The expression (i) is an equation for calculating the decrease −dI in the light intensity when a sample including a two-photon absorption compound and having a minute thickness dz is irradiated with light having an intensity of I. As obvious from the expression (i), the decrease −dI in the light intensity is represented by the sum of a term proportional to the first power of the intensity I of incident light on a sample and a term proportional to the square power of the intensity I.

$$- \frac{d I}{d z} = α I + {α}^{( 2 )} {I}^{2} \qquad ( i )$$

In the expression (i), α is a one-photon absorption coefficient (cm⁻¹), and α⁽²⁾ is a two-photon absorption coefficient (cm/W). It is recognized from the expression (i) that in a sample, the intensity I of incident light when the one-photon absorption amount and the two-photon absorption amount are equal to each other is represented by α/α⁽²⁾. That is, when the intensity I of incident light is lower than α/α⁽²⁾, one-proton absorption preferentially occurs in the sample. When the intensity I of incident light is higher than α/α⁽²⁾, two-photon absorption preferentially occurs in the sample. Accordingly, there is a tendency that the smaller the value of α/α⁽²⁾ in a sample, the more preferentially two-photon absorption can be expressed by laser light with a low light intensity.

Furthermore, α and α/α⁽²⁾ can be represented by the following expressions (ii) and (iii), respectively. In the expressions (ii) and (iii), ε is a molar absorption coefficient (mol⁻¹·L·cm⁻); N is the number of molecules of the compound per unit volume of the sample (mol·cm⁻³); N_{A} is an Avogadro constant; σ is a two-photon absorption cross-section (GM); h (h bar) is a Dirac constant (J·s); and ω is the angular frequency (rad/s) of incident light.

$$α = 1000 \cdot ln 10 \cdot ε \cdot \frac{N}{{N}_{A}} \qquad ( ii )$$

$${α}^{( 2 )} = \frac{σ N}{ℏ ω} \qquad ( iii )$$

It is recognized from the expressions (ii) and (iii) that α/α⁽²⁾ is decided by ε/σ. That is, in order to preferentially express two-photon absorption by laser light having a low light intensity, the ratio of the two-photon absorption cross-section a to the molar absorption coefficient ε, σ/ε, at the wavelength of the irradiating laser light is desirably large. When the value of the ratio σ/ε, of a compound is large at a specific wavelength, it is said that the nonlinearity of light absorption at the wavelength is high.

Japanese Patent Nos. 5769151 and 5659189 disclose compounds having large two-photon absorption cross-sections for light with a wavelength of about 405 nm. Japanese Patent No. 5821661 discloses an optical information recording medium that can shorten the writing time when laser light having a wavelength of about 405 nm is used and a compound included in the optical information recording medium.

Japanese Patent Nos. 5769151 and 5821661 describe compounds having a large π electron conjugated system. Furthermore, Japanese Patent No. 5659189 describes a benzophenone derivative having a large π electron conjugated system. However, when the π electron conjugated system of a compound expands, the two-photon absorption cross-section increases, while the peak derived from one-photon absorption tends to shift to the longer wavelength region. In the present specification, a shift of the peak derived from one-photon absorption to the longer wavelength region may be called a long wavelength shift or red shift. As a result of a long wavelength shift of a peak derived from one-photon absorption, the wavelength region where one-photon absorption occurs may partially overlap with the wavelength of excitation light. Incidentally, examples of the wavelength of excitation light include 405 nm defined in the specification of Blu-ray (registered trademark). In a compound, when the one-photon absorption by excitation light is large, the nonlinearity of light absorption tends to decrease. A compound with low nonlinearity of light absorption is unsuitable for a recording layer of a multi-layered three-dimensional optical memory.

Furthermore, in the benzophenone derivative disclosed in Japanese Patent No. 5659189, the quantum yield of intersystem crossing is almost 100%. This benzophenone derivative rapidly transits from a singlet excited state to a triplet excited state and therefore hardly emits fluorescence.

The present inventors have earnestly studied and as a result, have newly found that a compound represented by a formula (1) described below has a high nonlinear light absorption property for light having a wavelength in a short wavelength region, and the nonlinear light absorption material of the present disclosure has been accomplished. Specifically, the present inventors have found that in the compound represented by the formula (1), the ratio of the two-photon absorption cross-section σ to the molar absorption coefficient ε, σ/ε, for the light having a wavelength in a short wavelength region is large and the nonlinearity of light absorption is high. Furthermore, this compound also tends to have a fluorescence property. In the present specification, a short wavelength region means a wavelength region including 405 nm, for example, a wavelength region of 390 nm or more and 420 nm or less.

### Outline of an Aspect According to the Present Disclosure

A nonlinear light absorption material according to a 1st aspect of the present disclosure includes a compound represented by the following formula (1) as a main component:

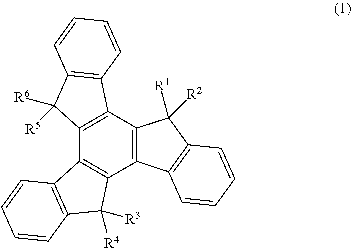

in the formula (1), R¹ to R⁶ are each independently a hydrocarbon group.

According to the 1st aspect, in the nonlinear light absorption material, the ratio of the two-photon absorption cross-section σ to the molar absorption coefficient ε, σ/ε, for light having a wavelength in a short wavelength region is large and the nonlinearity of light absorption tends to be high. Thus, in the nonlinear light absorption material, the nonlinear light absorption property for light having a wavelength in a short wavelength region is improved. The nonlinear light absorption material according to the 1st aspect also tends to have a fluorescence property.

In a 2nd aspect of the present disclosure, for example, in the nonlinear light absorption material according to the 1st aspect, R¹ to R⁶ may be each independently an alkyl group.

In a 3rd aspect of the present disclosure, for example, in the nonlinear light absorption material according to the 1st or 2nd aspect, R¹ to R⁶ may be each independently a methyl group or an ethyl group.

In a 4th aspect of the present disclosure, for example, in the nonlinear light absorption material according to any one of the 1st to 3rd aspects, R¹ to R⁶ may be the same as each other and may be methyl groups or ethyl groups.

In a 5th aspect of the present disclosure, for example, in the nonlinear light absorption material according to any one of the 1st to 4th aspects, the compound may have a nonlinear light absorption effect.

In a 6th aspect of the present disclosure, for example, the nonlinear light absorption material according to any one of the 1st to 5th aspects may be used in a device using light having a wavelength of 390 nm or more and 420 nm or less.

According to the 2nd to 6th aspects, in the nonlinear light absorption material, the nonlinear light absorption property for light having a wavelength in a short wavelength region is improved. The nonlinear light absorption material according to the 2nd to 5th aspects also tends to have a fluorescence property. This nonlinear light absorption material is suitable for use in devices using light having a wavelength of 390 nm or more and 420 nm or less.

A recording medium according to a 7th aspect of the present disclosure includes a recording layer including the nonlinear light absorption material according to any one of the 1st to 6th aspects.

According to the 7th aspect, in a nonlinear light absorption material, the nonlinear light absorption property for light having a wavelength in a short wavelength region is improved. The nonlinear light absorption material used in the 7th aspect also tends to have a fluorescent property. A recording medium including such a nonlinear light absorption material can record information with a high recording density.

A recording method for recording information according to an 8th aspect of the present disclosure comprises:
preparing a light source emitting light having a wavelength of 390 nm or more and 420 nm or less; and
collecting the light from the light source and irradiating the recording layer of the recording medium according to the 7th aspect with the light.

According to the 8th aspect, in the nonlinear light absorption material, the nonlinear absorption property for light having a wavelength in a short wavelength region is improved. The nonlinear light absorption material used in the 8th aspect also tends to have a fluorescence property. According to the method for recording information using a recording medium including the nonlinear light absorption material, information can be recorded with a high recording density.

A reading method for reading information according to a 9th aspect of the present disclosure is a method for reading information recorded by, for example, the recording method according to the 8th aspect, the reading method includes:
irradiating the recording layer of the recording medium with light to measure an optical characteristic of the recording layer; and
reading the information from the recording layer.

In a 10th aspect of the present disclosure, for example, in the reading method for reading information according to the 9th aspect, the optical characteristic may be the intensity of fluorescent light emitted from the recording layer.

According to the 9th or 10th aspect, when information is read, occurrence of crosstalk based on another recording layer can be suppressed.

Embodiment of the present disclosure will now be described with reference to the drawings. The present disclosure is not limited to the following embodiments. Embodiments

The nonlinear light absorption material of the present embodiment includes a compound A represented by the following formula (1):

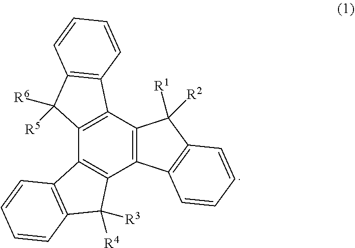

In the formula (1), R¹ to R⁶ are each independently a hydrocarbon group. The hydrocarbon group may be an aliphatic hydrocarbon group or an aromatic hydrocarbon group. Furthermore, the aliphatic hydrocarbon group may be an aliphatic saturated hydrocarbon group or an aliphatic unsaturated hydrocarbon group. A specific example of the aliphatic saturated hydrocarbon group is an alkyl group. R¹ to R⁶ may be each independently an alkyl group. The alkyl group may be linear, branched, or cyclic. The number of carbon atoms of the alkyl group is not particularly limited and is, for example, 1 or more and 20 or less. The number of carbon atoms of the alkyl group may be 1 or more and 10 or less or 1 or more and 5 or less from the viewpoint of being capable of easily synthesizing the compound A. The solubility of the compound A in a solvent or resin composition can be adjusted by adjusting the number of carbon atoms of the alkyl group. At least one of the hydrogen atoms included in the alkyl group may be substituted by a group including at least one atom selected from the group consisting of N, O, P, and S. Examples of the alkyl group include a methyl group, an ethyl group, a propyl group, a butyl group, a 2-methylbutyl group, a pentyl group, a hexyl group, a 2,3-dimethylhexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a 2-methoxybutyl group, and a 6-methoxyhexyl group. R¹ to R⁶ may be each independently a methyl group or an ethyl group.

The aliphatic unsaturated hydrocarbon group has an unsaturated bond such as a carbon-carbon double bond and a carbon-carbon triple bond. The number of the unsaturated bonds included in the aliphatic unsaturated hydrocarbon group is, for example, 1 or more and 5 or less. The number of carbon atoms of the aliphatic unsaturated hydrocarbon group is not particularly limited and is, for example, 2 or more and 20 or less and may be 2 or more and 10 or less or 2 or more and 5 or less. The aliphatic unsaturated hydrocarbon group may be linear, branched, or cyclic. Examples of the aliphatic unsaturated hydrocarbon group include a vinyl group and an ethynyl group.

The aromatic hydrocarbon group includes an aromatic ring. The aromatic ring is composed of, for example, carbon atoms. Examples of the aromatic ring include a benzene ring, a naphthalene ring, and an anthracene ring. The number of carbon atoms of the aromatic hydrocarbon group is not particularly limited and is, for example, 6 or more and 20 or less. Examples of the aromatic hydrocarbon group include a phenyl group and a benzyl group.

R¹ to R⁶ may be the same as or different from each other. As an example, R¹ to R⁶ may be the same as each other and may be methyl groups or ethyl groups. That is, specific examples of the compound A include 10,15-dihydro-5,5,10,10,15,15-hexamethyl-5H-diindeno[1,2-a:1′,2′-c]fluorene of the following formula (2) and 10,15-dihydro-5,5,10,10,15,15-hexaethyl-5H-diindeno[1,2-a:1′,2′-c]fluorene of the following formula (3):

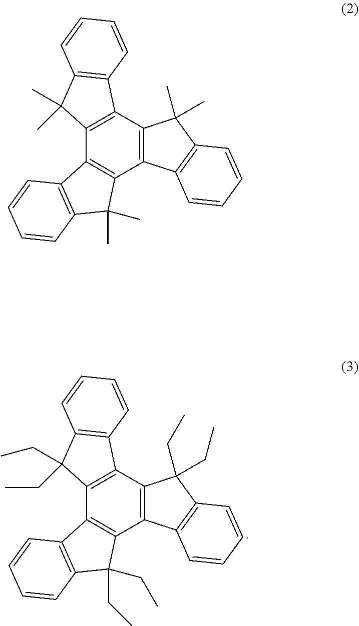

The compound A represented by the formula (1) has an excellent two-photon absorption property for light having a wavelength in a short wavelength region and tends to be low in one-photon absorption. As an example, when the compound A is irradiated with light having a wavelength of 405 nm, in the compound A, one-photon absorption may be little caused while two-photon absorption is caused.

The two-photon absorption cross-section of the compound A for light having a wavelength of 405 nm may be higher than 1 GM or 10 GM or more. The upper limit of the two-photon absorption cross-section of the compound A is not particularly limited and is, for example, 1000 GM. The two-photon absorption cross-section can be measured by, for example, the Z-scan method described in J. Opt. Soc. Am. B, 2003, Vol. 20, p. 529. The Z-scan method is broadly used as a method for measuring a nonlinear optical constant. In the Z-scan method, a measurement sample is moved along the irradiation direction of a laser beam near the focal point where the beam is focused. On this occasion, the change in the amount of light permeated through the measurement sample is recorded. In the Z-scan method, the power density of incident light changes depending on the position of the measurement sample. Accordingly, when the measurement sample performs nonlinear light absorption, if the measurement sample is located near the focal point of the laser beam, the amount of the transmitted light is attenuated. The two-photon absorption cross-section can be calculated by fitting the change of the amount of transmitted light to a theoretical curve predicted by the intensity of incident light, the thickness of the measurement sample, the concentration of the compound A in the measurement sample, and so on.

The molar absorption coefficient of the compound A for light having a wavelength of 405 nm may be 100 mol⁻¹·L·cm⁻¹ or less, 10 mol⁻¹·L·cm⁻¹ or less, 1 mol⁻¹·L·cm⁻¹ or less, or 0.1 mol⁻¹·L·cm⁻¹ or less. The lower limit of the molar absorption coefficient of the compound A is not particularly limited and is, for example, 0.00001 mol⁻¹·L·cm⁻¹. The molar absorption coefficient can be measured by, for example, a method in accordance with the provision of Japanese Industrial Standards (JIS) K0115:2004. The measurement of molar absorption coefficient uses a light source that irradiates light with a photon density to hardly cause two-photon absorption by the compound A. Furthermore, in the measurement of molar absorption coefficient, the concentration of the compound A is adjusted to 100 mmol/L or more and 500 mmol/L or less. This concentration is very high compared to the concentration in a measurement test of the molar absorption coefficient of a light absorption peak. The molar absorption coefficient can be used as an index of one-photon absorption.

In the compound A, the ratio of the two-photon absorption cross-section σ (GM) to the molar absorption coefficient ε(mol⁻¹·L·cm⁻¹), σ/ε, for light having a wavelength in a short wavelength region is large. The ratio a/c of the compound A for light having a wavelength of 405 nm may be 100 or more, 300 or more, 500 or more, 700 or more, or 900 or more. The upper limit of the ratio σ/ε of the compound A is not particularly limited and is, for example, 5000.

When the compound A performs two-photon absorption, the compound A absorbs energy about twice that of light applied to the compound A. The wavelength of light having energy about twice that of the light having a wavelength of 405 nm is, for example, 200 nm. When the compound A is irradiated with light having a wavelength of about 200 nm, one-photon absorption may occur in the compound A. Furthermore, in the compound A, one-photon absorption may occur for light having a wavelength near the wavelength region where two-photon absorption is caused.

The compound A also tends to emit fluorescent light. The wavelength of fluorescent light emitted by the compound A may be 405 nm or more and 660 nm or less and, in some cases, may be 300 nm or more and 650 nm or less. The quantum yield Φf of fluorescence in the compound A may be 0.05 or more, 0.1 or more, or 0.5 or more. The upper limit of the quantum yield Φf of fluorescence of the compound A is not particularly limited and is, for example, 0.99. In the present specification, the “quantum yield” specifically means internal quantum yield. The quantum yield of fluorescence can be measured by, for example, a commercially available absolute PL quantum yield measuring apparatus.

The nonlinear light absorption material of the present embodiment may contain the compound A represented by the formula (1) as a main component. The term “main component” means the most abundant component by weight included in the nonlinear light absorption material. The nonlinear light absorption material, for example, substantially consists of the compound A. The phrase “substantially consist of” means to exclude other components that change the essential characteristics of the material referred to. However, the nonlinear light absorption material may include impurities in addition to the compound A. The nonlinear light absorption material including the compound A of the present embodiment functions as, for example, a two-photon absorption material.

In general, in order to improve the nonlinearity of light absorption by a compound in a wavelength region of 390 nm or more and 420 nm or less, it is required not only that the compound has a nonlinear light absorption property in the wavelength region but also that the one-photon absorption by the compound in the wavelength region is very small. In adjustment of an optical characteristic of a material with a low concentration of a nonlinear light absorption compound, the optical characteristics of the compound itself may be considered. That is, the molar absorption coefficient in a wavelength region of 390 nm or more and 420 nm or less can be decreased by adopting a compound having a lowest one-photon-allowed state corresponding to the energy of light having a wavelength sufficiently shorter than the wavelength region of 390 nm or more and 420 nm or less and having a small oscillator strength. However, in industrial use, a material having a high concentration of a nonlinear light absorption compound is required. When the concentration of a nonlinear light absorption compound is high, the compound molecules come close to each other and may be assembled through 7C-7C interaction or the like. The occurrence of the assembly may change the optical characteristics of the compound itself.

Unsubstituted truxene is a hydrocarbon compound that is nonpolar and has a high planarity. Unsubstituted truxene corresponds to the compound of the above formula (1) in which R¹ to R⁶ are hydrogen atoms. In the present specification, the unsubstituted truxene may be simply called truxene. In truxene, 7C stacking of the molecules is likely to occur, and the solubility in a solvent or resin monomer tends to be low. For example, when chloroform is used as the solvent, the solubility of truxene is about several mmol/L. When the concentration of truxene in a material is high, truxene molecules come close to each other and are assembled in various forms. Consequently, multiple new levels are formed at positions with energies lower than the lowest one-photon-allowed state of truxene itself. Accordingly, tailing of a peak derived from one-photon absorption can be verified by measuring the one-photon absorption spectrum of the material including truxene at a high concentration. In contrast, in the compound A represented by the formula (1) in which R¹ to R⁶ are hydrocarbon groups, it tends to suppress the formation of assembly of compound molecules without substantially changing the size of the π C electron conjugated system of truxene. Therefore, regarding the compound A, even if it is present at a high concentration in the material, tailing of the peak derived from one-photon absorption is suppressed. That is, even if the compound A is present at a high concentration in a material, the molar absorption coefficient for light in a wavelength region of 390 nm or more and 420 nm or less is small, the nonlinearity of light absorption tends to be high. Furthermore, the compound A also tends to have a high solubility in a solvent or resin monomer. For example, when chloroform is used as a solvent, the solubility of the compound represented by the formula (1) in which R¹ to R⁶ are methyl groups is 100 mmol/L or more.

The nonlinear light absorption material of the present embodiment is used in, for example, a device using light having a wavelength in a short wavelength region. As an example, the nonlinear light absorption material of the present embodiment is used in a device using light having a wavelength of 390 nm or more and 420 nm or less. Examples of the device include a recording medium, a shaping device, and a fluorescence microscope. Examples of the recording medium include a three-dimensional optical memory. A specific example of the three-dimensional optical memory is a three-dimensional optical disk. Examples of the shaping device include a three-dimensional (3d) laser microfabrication device such as a 3D printer. Examples of the fluorescence microscope include a two-photon fluorescence microscope. The light used in these devices has, for example, a high photon density near the focal point. The power density near the focal point of the light that is used in the device is, for example, 0.1 W/cm² or more and 1.0×10²⁰W/cm² or less. The power density near the focal point of this light may be 1.0 W/cm² or more, 1.0×10²W/cm² or more, or 1.0×10⁵ W/cm² or more. As the light source of the device, for example, it is possible to use a femtosecond laser such as a titanium sapphire laser or a pulsed laser having a picosecond to nanosecond pulse width such as a semiconductor laser.

The recording medium includes, for example, a thin film called a recording layer. In the recording medium, information is recorded in the recording layer. As an example, a thin film as the recording layer includes the nonlinear light absorption material of the present embodiment. That is, from another aspect, the present disclosure provides a recording medium including a nonlinear light absorption material including the compound A above.

The recording layer may further include a polymer compound that functions as a binder, in addition to the nonlinear light absorption material. The recording medium may include a dielectric layer in addition to the recording layer. The recording medium includes, for example, a plurality of recording layers and a plurality of dielectric layers. In the recording medium, a plurality of recording layers and a plurality of dielectric layers may be alternately stacked.

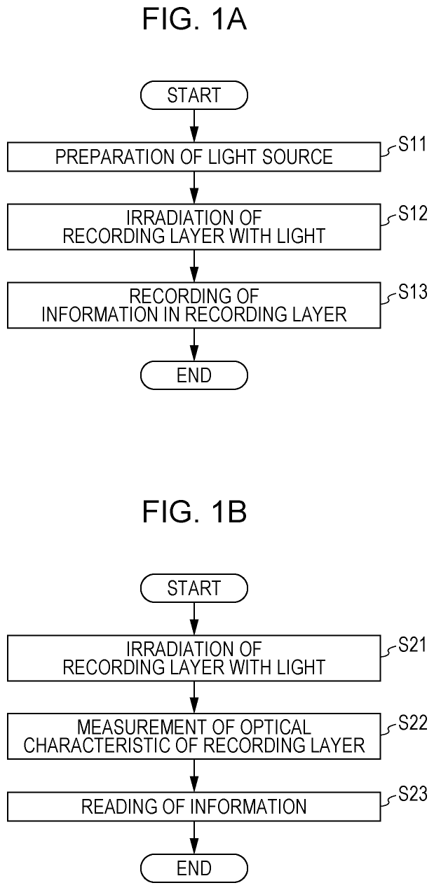

Then, a method for recording information using the recording medium above will be described. FIG. 1A is a flow chart of a method for recording information using the recording medium. First, in step S11, a light source that emits light having a wavelength of 390 nm or more and 420 nm or less is prepared. As the light source, for example, it is possible to use a femtosecond laser such as a titanium sapphire laser or a pulsed laser having a picosecond to nanosecond pulse width such as a semiconductor laser. Then, in step S12, the light from the light source is condensed with a lens or the like and is applied to the recording layer of the recording medium. Specifically, the light from the light source is condensed with a lens or the like and is applied to the recording area of the recording medium. The power density near the focal point of this light is, for example, 0.1 W/cm² or more and 1.0×10²⁰ W/cm² or less. This power density near the focal point of the light may be 1.0 W/cm² or more, 1.0×10² W/cm² or more, or 1.0×10⁵ W/cm ² or more. In the present specification, the recording area means a spot that is present in a recording layer and can record information by being irradiated with light.

In the recording area irradiated with light, a physical change or a chemical change occurs to change the optical characteristics of the recording area. For example, the intensity of fluorescent light emitted from the recording area is decreased. In the recording area irradiated with light, the intensity of light reflected at the recording area, the reflectance of light at the recording area, the absorptance of light at the recording area, the refractive index of light in the recording area, the wavelength of fluorescent light emitted from the recording area, and so on may also change. Consequently, information can be recorded in the recording layer, specifically, in the recording area (step S13).

Then, a method for reading information using the recording medium will be described. FIG. 1B is a flow chart of a method for reading information using the recording medium. First, in step S21, the recording layer of the recording medium is irradiated with light. Specifically, the recording area of the recording medium is irradiated with light. The light used in step S21 may be the same as or different from the light used for recording information on the recording medium. Then, in step S22, an optical characteristic of the recording layer is measured. Specifically, an optical characteristic of the recording area is measured. In step S22, for example, the intensity of fluorescent light emitted from the recording area is measured. In step S22, as the optical characteristic of the recording area, for example, the intensity of light reflected at the recording area, the reflectance of light at the recording area, the absorptance of light at the recording area, the refractive index of light in the recording area, or the wavelength of fluorescent light emitted from the recording area may be measured. Then, in step S23, information is read out from the recording layer, specifically, from the recording area.

In the method for reading information, the recording area where information is recorded can be located by the following method. First, a specific area of the recording medium is irradiated with light. This light may be the same as or different from the light used for recording information on the recording medium. Then, an optical characteristic of the area irradiated with the light is measured. Examples of the optical characteristic include the intensity of fluorescent light emitted from the area, the intensity of light reflected at the area, the reflectance of light at the area, the absorptance of light at the area, the refractive index of light in the area, and the wavelength of fluorescent light emitted from the area. Whether an area irradiated with light is a recording area or not is judged based on the measured optical characteristic. For example, when the intensity of fluorescent light emitted from an area is a specific value or less, the area is judged to be a recording area. In contrast, when the intensity of fluorescent light exceeds a specific value, the area is judged not to be a recording area. Incidentally, the method for judging whether an area irradiated with light is a recording area or not is not limited to the above method. For example, when the intensity of fluorescent light emitted from an area exceeds a specific value, the area may be judged to be a recording area. Alternatively, when the intensity of fluorescent light emitted from an area is a specific value or less, the area may be judged not to be a recording area. When an area is judged not to be a recording area, the same procedure is performed for another area of the recording medium. Consequently, a recording area can be located.

The recording method and reading method of information using the recording medium can be performed with, for example, a known recording apparatus. The recording apparatus includes, for example, a light source for irradiating the recording area of a recording medium with light, a measuring device of measuring an optical characteristic of the recording area, and a controller for controlling the light source and the measuring device.

The shaping device performs shaping by, for example, irradiating a photocurable resin composition with light to cure the resin composition. As an example, a photocurable resin composition for three-dimensional (3d) laser microfabrication includes a nonlinear light absorption material of the present embodiment. The photocurable resin composition includes, for example, a polymerizable compound and a polymerization initiator, in addition to the nonlinear light absorption material. The photocurable resin composition may further include an additive such as a binder resin. The photocurable resin composition may include an epoxy resin.

A fluorescence microscope can, for example, irradiate a biological specimen including a fluorescent dye material with light and observe fluorescence emitted from the dye material. As an example, the fluorescent dye material to be added to a biological specimen includes the nonlinear light absorption material of the present embodiment. Examples

The present disclosure will now be described in more detail by examples. Incidentally, the following examples are merely examples, and the present disclosure is not limited to the following examples.

First, compounds of Examples 1 and 2 and Comparative Examples 1 to 6 shown in Table 1 were prepared. The compounds of Comparative Examples 1 to 6 are represented by the formulae (4) to (9) below, respectively.

Here, 10,15-dihydro-5,5,10,10,15,15-hexamethyl-5H-diindeno[1,2-a:1′,2′-c]fluorene used as the compound of Example 1 and 10,15-dihydro-5,5,10,10,15,15-hexaethyl-5H-diindeno[1,2-a:1′,2′-c]fluorene used as the compound of Example 2 were synthesized according to the method described in Mao-Sen Yuan et al., “Donor-and-Acceptor Substituted Truxenes as Multifunctional Fluorescent Probes”, J. Org. Chem., 2007, Vol. 72, pp.7915-7922.

Truxene (10,15-dihydro-5H-diindeno[1,2-a:1′,2′-c]fluorene) used as the compound of Comparative Example 1 was that manufactured by Tokyo Chemical Industry Co., Ltd., truxenone (5H-diindeno[1,2-a:1′,2′-c]fluorene-5,10,15-trione) used as the compound of Comparative Example 2 was that manufactured by Tokyo Chemical Industry Co., Ltd., and triazatruxene (10,15-dihydro-5H-5,10,15-triaza-diindeno[1,2-a:1′,2′-c]fluorene) used as the compound of Comparative Example 3 was that manufactured by Sigma-Aldrich Co. LLC.

Hexakis(phenylethynyl)benzene (HPEB) used as the compound of Comparative Example 4 was synthesized according to the method described in K. Konodo et al., J. Chem. Soc., Chem. Commun., 1995, 55-56; and W. Tao, et al., J. Org. Chem., 1990, 55, 63-66. The compound D29 used as the compound of Comparative Example 5 represented by the formula (8) below was synthesized according to the method described in paragraphs
to of Japanese Patent No. 5659189. The compound if used as the compound of Comparative Example 6 represented by the formula (9) below was synthesized according to the method described in paragraph of Japanese Patent No. 5821661.

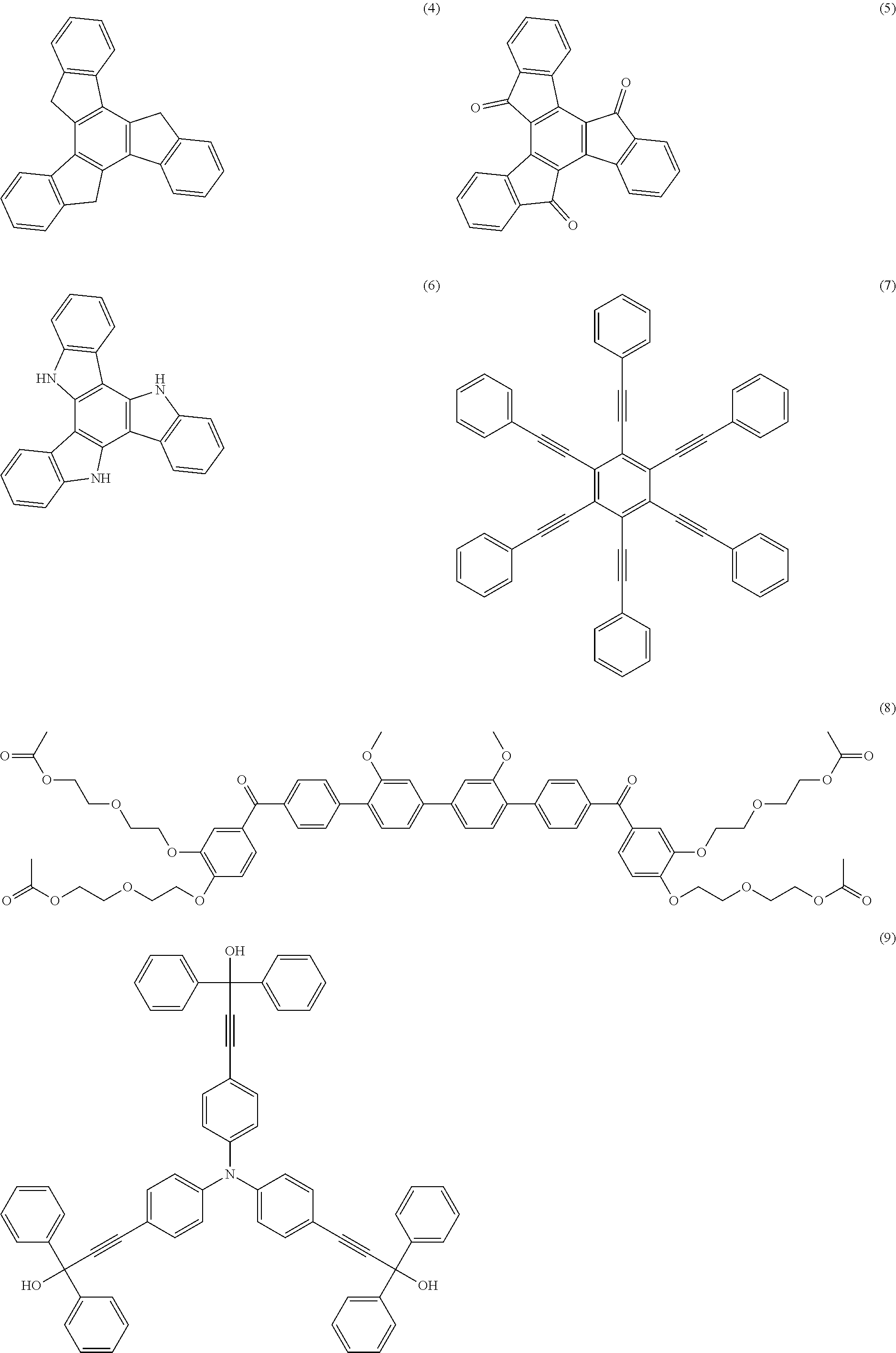

The compounds of Examples and Comparative Examples were measured for optical characteristics by the following methods. However, the compound of Comparative Example 2 had a low solubility in the solvent, and a sample for measuring the optical characteristics could not be prepared. Furthermore, the compound of Comparative Example 3 had a low stability for light having a wavelength in a short wavelength region, and the optical characteristics could not be measured. These results demonstrate that the compounds of Comparative Examples 2 and 3 are unsuitable for use in devices using light having a wavelength of 390 nm or more and 420 nm or less. Measurement of two-photon absorption cross-section

The compounds of Examples and Comparative Examples were measured for the two-photon absorption cross-section for light having a wavelength of 405 nm. The measurement of the two-photon absorption cross-section was performed using the Z-scan method described in J. Opt. Soc. Am. B, 2003, Vol. 20, p. 529. As the light source for measuring the two-photon absorption cross-section, a titanium sapphire pulsed laser was used. Specifically, each sample was irradiated with the second harmonic of the titanium sapphire pulsed laser. The pulse width of the laser was 80 fs. The repetition frequency of the laser was 1 kHz. The average power of the laser was changed within a range of 0.01 mW or more and 0.08 mW or less. The light from the laser was light having a wavelength of 405 nm. Specifically, the light from the laser had a central wavelength of 403 nm or more and 405 nm or less. The light from the laser had a full width at half maximum of 4 nm. As described above, the two-photon absorption cross-sections of the compounds of Examples 1 and 2 and the compounds of Comparative Examples 1 and 4 to 6 were measured.

### Measurement of Molar Absorption Coefficient

The compounds of Examples and Comparative Examples were measured for the molar absorption coefficient by a method in accordance with the provision of JIS K0115:2004. Specifically, first, as a measurement sample, a solution in which a compound was dissolved in a solvent was prepared. The concentration of the compound in the solution was appropriately adjusted within a range of 100 mmol/L or more and 500 mmol/L or less according to the absorbance at a wavelength of 405 nm of the compound as the target for measurement. Then, the absorption spectrum of the measurement sample was measured. The absorbance at a wavelength of 405 nm was read from the obtained spectrum. The molar absorption coefficient was calculated based on the concentration of the compound in the measurement sample and the optical path length of the cell used for the measurement. As described above, the molar absorption coefficients of the compounds of Examples 1 and 2 and the compounds of Comparative Examples 1 and 4 to 6 were measured.

### Measurement of Quantum Yield of Fluorescence

The compounds of Examples and Comparative Examples were measured for fluorescence internal quantum yield. The measurement sample was prepared by dissolving a compound in a chloroform (CLF) solvent or a tetrahydrofuran (THF) solvent. In the measurement, an absolute PL quantum yield measuring apparatus (C9920-02, manufactured by Hamamatsu Photonics K.K.) was used. The excitation wavelength was set to the peak wavelength of the one-photon absorption of the compound. The measurement wavelength was appropriately adjusted within a range of 350 nm or more and 650 nm or less so as not to overlap with the absorption wavelength band of the compound. As a reference, the solvent used for dissolving the compound was used. As described above, the fluorescence quantum yields of the compounds of Examples 1 and 2 and the compounds of Comparative Examples 1 and 4 to 6 were measured.

Table 1 shows the two-photon absorption cross-section σ (GM), molar absorption coefficient ε (mol⁻¹·L·cm⁻¹), ratio σ/ε, and fluorescence quantum yield Φf (−) obtained by the methods above.

TABLE 1

| | | | Two-photon | Molar | | |
|---|---|---|---|---|---|---|
| | | | absorption | absorption | | Fluorescence |
| | Compound | | cross-section | coefficient ε | Ratio | quantum |
| | Name | Formula | σ (GM) | (mol⁻¹ · L · cm⁻¹) | σ/ε | yield Φf (—) |
| Example 1 | 10,15-Dihydro-5,5,10,10,15,15- | (2) | 40 | 0.04 | 1000 | 0.1 |
| | hexamethyl-5H-diindeno[1,2- | | | | | |
| | a:1′,2′-c]fluorene | | | | | |
| Example 2 | 10,15-Dihydro-5,5,10,10,15,15- | (3) | 43 | 0.08 | 540 | 0.1 |
| | hexaethyl-5H-diindeno[1,2- | | | | | |
| | a:1′,2′-c]fluorene | | | | | |
| Comparative | Truxene (10,15-dihydro-5H- | (4) | 180 | 24 | 8 | 0.1 |
| Example 1 | diindeno[1,2-a:1′,2′-c]fluorene) | | | | | |
| Comparative | Truxenone (5H-diindeno[1,2- | (5) | — | — | — | — |
| Example 2 | a:1′,2′-c]fluorene-5,10,15- | | | | | |
| | trione) | | | | | |
| Comparative | Triazatruxene (10,15-dihydro- | (6) | — | — | — | — |
| Example 3 | 5H-5,10,15-triaza-diindeno[1,2- | | | | | |
| | a:1′,2′-c]fluorene) | | | | | |
| Comparative | Hexakis(phenylethynyl)benzene | (7) | 23000 | 2730 | 10 | 0.1 or more |
| Example 4 | (HPEB) | | | | | 0.3 or less |
| Comparative | D29 | (8) | 570 | 35 | 15 | 0 |
| Example 5 | | | | | | |
| Comparative | 1f | (9) | 380 | 70 | 5 | 0.3 |
| Example 6 | | | | | | |

As obvious from Table 1, in both the compounds of Examples 1 and 2 corresponding to the compound A represented by the formula (1), the values of the ratio a/c for light having a wavelength of 405 nm were larger than those of the compounds of Comparative Examples and exceeded 500. This result demonstrates that the compound A has a high nonlinearity of light absorption for light having a wavelength in a short wavelength region and has an improved nonlinear light absorption property. Furthermore, the compounds of Examples 1 and 2 also had a fluorescence property. In the truxene of Comparative Example 1, the two-photon absorption cross-section σ exceeded 100 GM, but the molar absorption coefficient ε was a very large value compared to those in Examples. Consequently, in Comparative Example 1, the ratio σ/ε was a small value. As described above, since truxene has a high planarity, it is inferred that in a high concentration measurement sample, the compound molecules came close to each other by π-π interaction, consequently, multiple new levels were formed at positions with energies lower than the lowest one-photon-allowed state of truxene itself, and as a result, tailing of the peak derived from one-photon absorption was caused to increase the molar absorption coefficient ε.

In contrast, in the compound A, the substituents R¹ to R⁶ extend in a direction different from the direction in which the plane of the truxene skeleton spreads. For example, in the compound A, the substituents extend up and down with respect to the plane the truxene skeleton. In the compound A, since steric hindrance is caused by the substituents R¹ to R⁶, the compound molecules are unlikely to come close to each other. Consequently, it is inferred that in Examples 1 and 2, even if the concentration of the compound in a measurement sample was high, tailing of the peak derived from one-photon absorption was suppressed and the value of the molar absorption coefficient ε was small.

The compounds of Comparative Examples 4 to 6 are compounds different from truxene derivatives. In all these compounds, the value of ratio σ/ε for light having a wavelength of 405 nm was lower than 100. Since the compounds of Comparative Examples 4 to 6 have a large π electron conjugated system, the transition dipole moment is large. Accordingly, in Comparative Examples 4 to 6, the value of two-photon absorption cross-section σ was large. However, in a compound having an extended π electron conjugated system, the peak derived from one-photon absorption tends to shift to the longer wavelength region. It is inferred that in the compounds of Comparative Examples 4 to 6, the wavelength region where one-photon absorption occurs partially overlaps with 405 nm to significantly increase the molar absorption coefficient ε, and consequently, the value of the σ/ε was small.

The nonlinear light absorption material of the present disclosure can be used in applications, such as a recording layer of a three-dimensional optical memory and a photocurable resin composition for three-dimensional (3d) laser microfabrication. The nonlinear light absorption material of the present disclosure has a light absorption property exhibiting high nonlinearity for light having a wavelength in a short wavelength region. Accordingly, the nonlinear light absorption material of the present disclosure can achieve a significantly high spatial resolution in application such as a three-dimensional optical memory and a shaping device. Furthermore, in the nonlinear light absorption material of the present disclosure, the fluorescence quantum yield also tends to be high. Accordingly, if the nonlinear light absorption material is used for a recording layer of a three-dimensional optical memory, a system of reading the ON/OFF state of a recording layer based on the change in the fluorescence from the nonlinear light absorption material can be adopted. The nonlinear light absorption material of the present disclosure can also be used in a fluorescent dye material for two-photon fluorescence microscope or the like. The nonlinear light absorption material of the present disclosure can cause preferentially two-photon absorption than one-photon absorption, compared to existing nonlinear light absorption materials, even when irradiated with laser light having at a low light intensity.

What is claimed is:

1. A nonlinear light absorption material comprising:
a compound represented by a formula (1) as a main component: 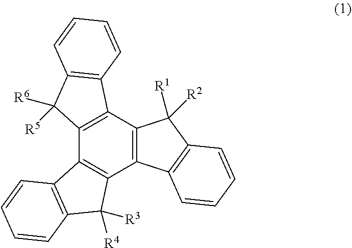
in the formula (1), R¹ to R⁶ are each independently a hydrocarbon group.

2. The nonlinear light absorption material according to claim 1, wherein R¹ to R⁶ are each independently an alkyl group.

3. The nonlinear light absorption material according to claim 1, wherein R¹ to R⁶ are each independently a methyl group or an ethyl group.

4. The nonlinear light absorption material according to claim 1, wherein R¹ to R⁶ are the same as each other and are methyl groups or ethyl groups.

5. The nonlinear light absorption material according to claim 1, wherein the compound has a nonlinear light absorption effect.

6. The nonlinear light absorption material according to claim 1, wherein the nonlinear light absorption material is used in a device using light having a wavelength of 390 nm or more and 420 nm or less.

7. A recording medium comprising:
a recording layer including the nonlinear light absorption material according to claim 1.

8. A recording method for recording information, the recording method comprising:
preparing a light source emitting light having a wavelength of 390 nm or more and 420 nm or less; and
collecting the light from the light source and irradiating the recording layer of the recording medium according to claim 7 with the light.

9. A reading method for reading information recorded by the recording method according to claim 8, the reading method comprising:
irradiating the recording layer of the recording medium with light to measure an optical characteristic of the recording layer; and
reading the information from the recording layer.

10. The reading method according to claim 9, wherein
the optical characteristic is intensity of fluorescent light emitted from the recording layer.
